(19) United States
(12) Patent Application Publication
(10) Pub. No.: US 2018/0257139 A1
(43) Pub. Date: Sep. 13, 2018

(54) MODULAR MOLD FOR MAKING INDUCTORS

(71) Applicant: U.D.ELECTRONIC CORP., Taoyuan City (TW)

(72) Inventors: Yu-Chin HSU, Taoyuan City (TW); Yao-Ching HUANG, Taoyuan City (TW)

(21) Appl. No.: 15/457,931

(22) Filed: Mar. 13, 2017

(51) Int. Cl. B22F 3/03; B22F 7/08; H01F 41/02

(52) U.S. Cl. CPC B22F 3/03; H01F 41/02; H01F 41/0246; B22F 7/08

(57) ABSTRACT

A modular mold includes a forming mold for mounting on the lower mold base of a punching machine, a stereotype plate for mounting on the upper mold base of the punching machine, and a movable fixture plate defining therein an array of forming spaces for accommodating coils of a material part and a magnetic powder. The movable fixture plate with the loaded material part is set in between the forming mold and the stereotype plate for cutting and compression shape forming, and then removed from the forming mold and the stereotype plate for baking to cure the magnetic powder in the forming spaces, forming the desired inductors.

### BACKGROUND OF THE INVENTION

### 1. Field of the Invention

The present invention relates to inductor manufacturing technology and more particularly, to a modular mold for making inductors, which uses a movable fixture plate to hold a material part and a magnetic powder for processing, prohibiting the inductors thus made from thermal expansion or cracking during the curing process, and thus, facilitating induction production and improving the yield rate.

### 2. Description of the Related Art

In the fabrication of inductors according to conventional techniques, iron powder is filled in a forming mold in a punching machine, and then the punching machine is operated to compact the iron powder into semi-finished inductors, and then the semi-finished inductors are removed from the forming mold for baking and electrode piece mounting. However, when baking the iron powder of the semi-finished inductors, cracking can be created in the iron powder. As illustrated, creating a2 is created in the inductor a during the baking process, resulting in yield declines.

### SUMMARY OF THE INVENTION

The present invention has been accomplished under the circumstances in view. It is therefore the main object of the present invention to provide a modular mold for making inductors, which facilitates inductor production and prohibits the inductors from thermal expansion or cracking during the curing process, improving the yield rate.

To achieve this and other objects of the present invention, a modular mold comprises a forming mold for mounting on the lower mold base of a punching machine, a stereotype plate for mounting on the upper mold base of the punching machine, and a movable fixture plate defining therein an array of forming spaces for accommodating coils of a material part and a magnetic powder. The movable fixture plate with the loaded material part is set in between the forming mold and the stereotype plate for cutting and compression shape forming, and then removed from the forming mold and the stereotype plate for baking to cure the magnetic powder in the forming spaces, forming the desired inductors. During the baking process to cure the magnetic powder, the magnetic powder is surrounded by the peripheral walls of the respective forming spaces of the movable fixture plate, there is no space for lateral expansion, prohibiting the magnetic powder from thermal expansion or cracking.

### BRIEF DESCRIPTION OF THE DRAWINGS

FIG. 1 is an exploded view of a modular mold for making inductors in accordance with the present invention.

FIG. 2 is an exploded view of the movable fixture plate and the forming mold.

FIG. 3 is an oblique top elevational view of the present invention, illustrating the movable fixture plate and the forming mold assembled.

FIG. 4 is a schematic exploded view of the movable fixture plate and the material part.

FIG. 5 is a schematic drawing illustrating the implementation of the process of cutting and magnetic powder squeezing in the inductor preparation (I).

FIG. 6 is a schematic drawing illustrating the implementation of the process of cutting and magnetic powder squeezing in the inductor preparation (II).

FIG. 7 is an enlarged view of part A of FIG. 6.

FIG. 8 is a schematic drawing illustrating the implementation of the process of cutting and magnetic powder squeezing in the inductor preparation (III).

FIG. 9 is an enlarged view of part B of FIG. 8.

FIG. 10 is a schematic drawing illustrating the magnetic powder processed in the movable fixture plate in the curing process.

FIG. 11 is a sectional view of an inductor made according to the present invention.

FIG. 12 is a schematic drawing illustrating cracking created in an inductor made according to the prior art.

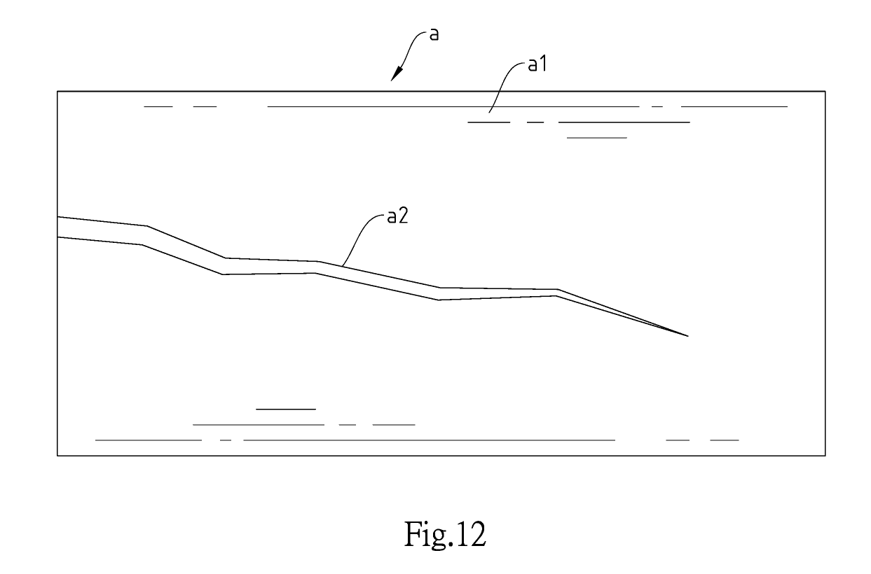

### DETAILED DESCRIPTION OF THE PREFERRED EMBODIMENT

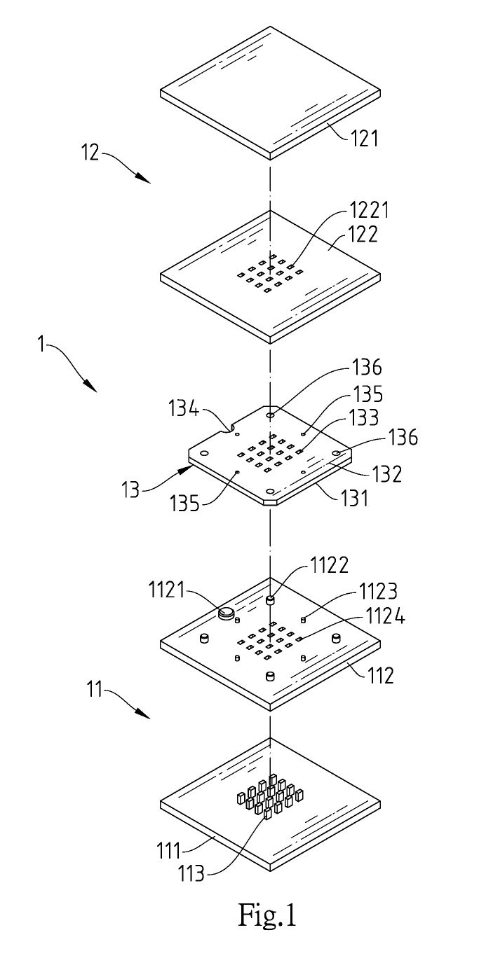

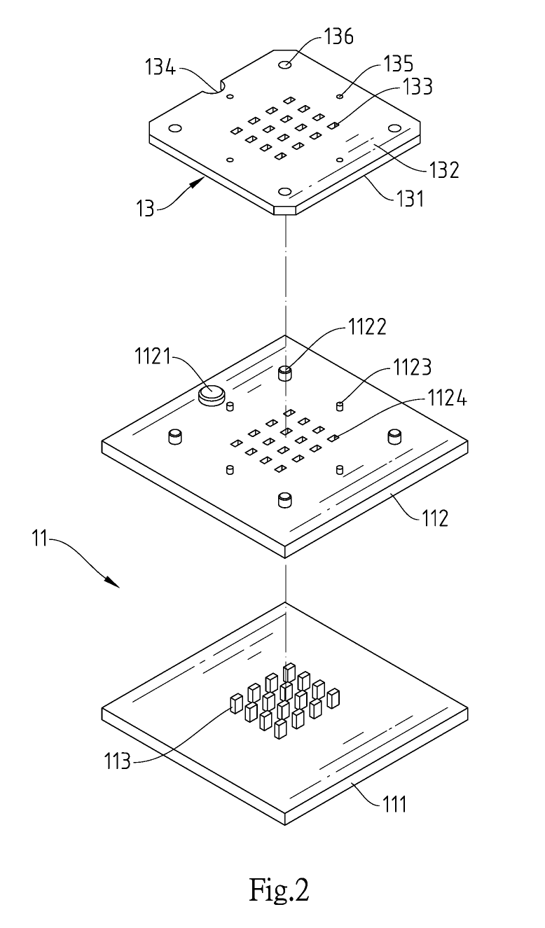

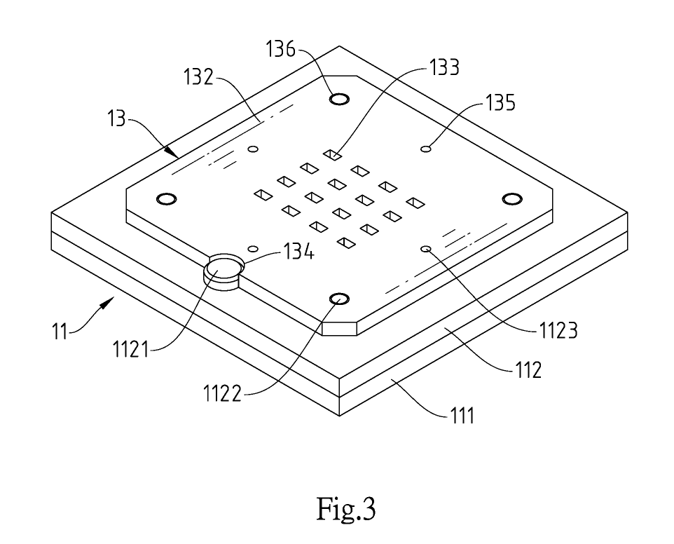

Referring to FIGS. 1-5, a modular mold for making inductors in accordance with the present invention is shown. The modular mold comprises a forming mold 11, a stereotype plate 12 and a movable fixture plate 13.

The forming mold 11 comprises a lower template 111, a lower slider 112 and a plurality of lower punches 113. The lower template 111 is mounted on a top surface of a lower mold base 41 of a punching machine 4. Further, spring spacers 5 are mounted between the lower template 111 and the lower slider 112. The lower punches 113 are arranged on the lower template 111 in an array. The lower slider 112 comprises a positioning post 1121, a plurality of support columns 1122 and a plurality of locating pins 1123 respectively upwardly extended from the top surface thereof and a plurality of through holes 1124 cut through the opposing top and bottom surfaces thereof and respectively aimed at the lower punches 113. Further, the length (height) of the through holes 1124 is shorter than the length (height) of the lower punches 113 so that when the lower slider 112 is compressed to move the through holes 1124 relative to the lower punches 113, the lower punches 113 can protrude over the top surface of the lower slider 112.

The stereotype plate 12 comprises a substrate 121, an upper slider 122 and a plurality of upper punches 123. The substrate 121 is mounted on a bottom surface of an upper mold base 42 of the punching machine 4. Further, spring spacers 5 are mounted between the substrate 121 and the upper slider 122. The upper punches 123 are arranged on a bottom surface of the substrate 121 in an array. The upper slider 122 comprises a plurality of through holes 1221 cut through opposing top and bottom surfaces thereof and respectively aimed at the upper punches 123. Further, the length (height) of the through holes 1221 is smaller than the length (height) of the upper punches 123 so that when the upper slider 122 is compressed to move the through holes 1221 relative to the upper punches 123, the upper punches 123 can protrude over the bottom surface of the upper slider 122.

The movable fixture plate 13 is movable relative to the forming mold 11 and the stereotype plate 12, comprising a first bearing surface 131, a second bearing surface 132 opposite to the first bearing surface 131, forming spaces 133 cut through the first bearing surface 131 and the second bearing surface 132, a positioning notch 134 located on a peripheral edge thereof, and a plurality of guide holes 135 and a plurality of locating holes 136 cut through the first bearing surface 131 and the second bearing surface 132.

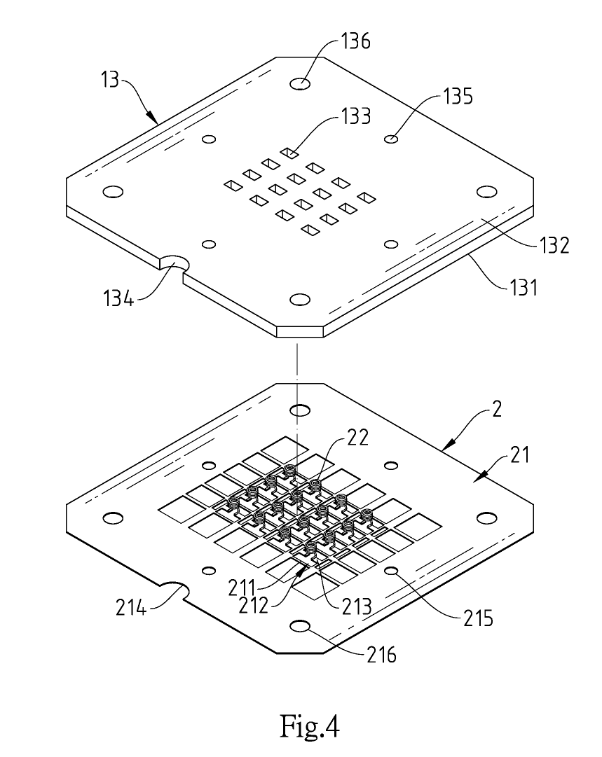

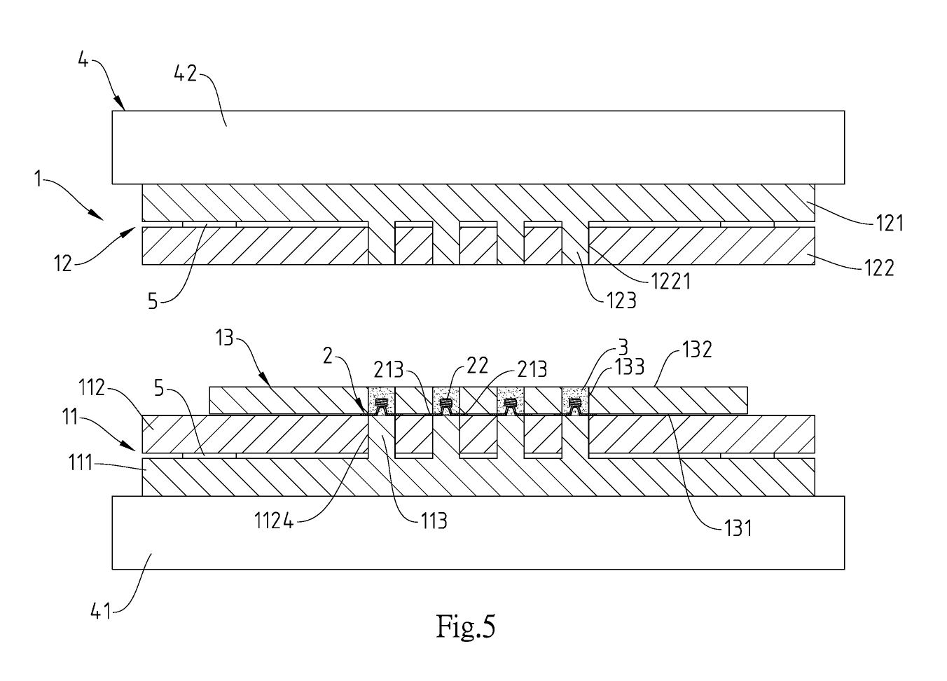

As illustrated in FIGS. 4 and 5, the movable fixture plate 13 is adapted for securing a material part 2. The material part 2 comprises a lead frame 21, and a plurality of coils 22 connected to the lead frame 21. The lead frame 21 is a flat frame, comprising a plurality of connecting pieces 211, a plurality of openings 212 respectively surrounded by the connecting pieces 211, a plurality of electrode pieces 213 respectively extended from the connecting pieces 211 and suspending in the openings 212, a position-limiting notch 214 located on a peripheral edge thereof, and a plurality of first position-limiting holes 215 and second position-limiting holes 216 cut through opposing top and bottom surfaces thereof and spaced around the connecting pieces 211. The coils 22 are respectively connected to one respective pair of electrode pieces 213, and respectively disposed corresponding to one respective opening 212.

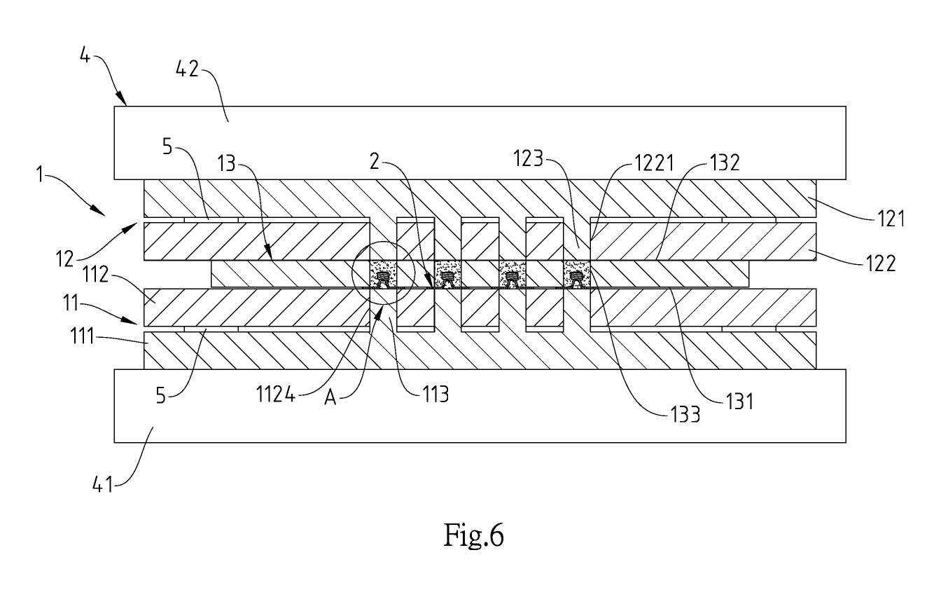

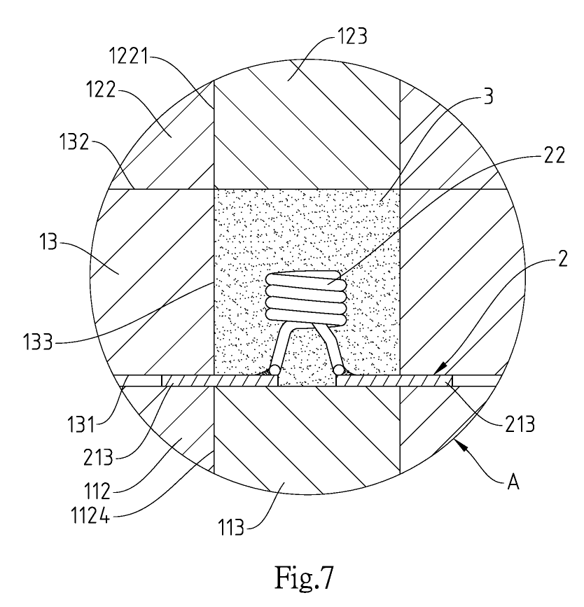

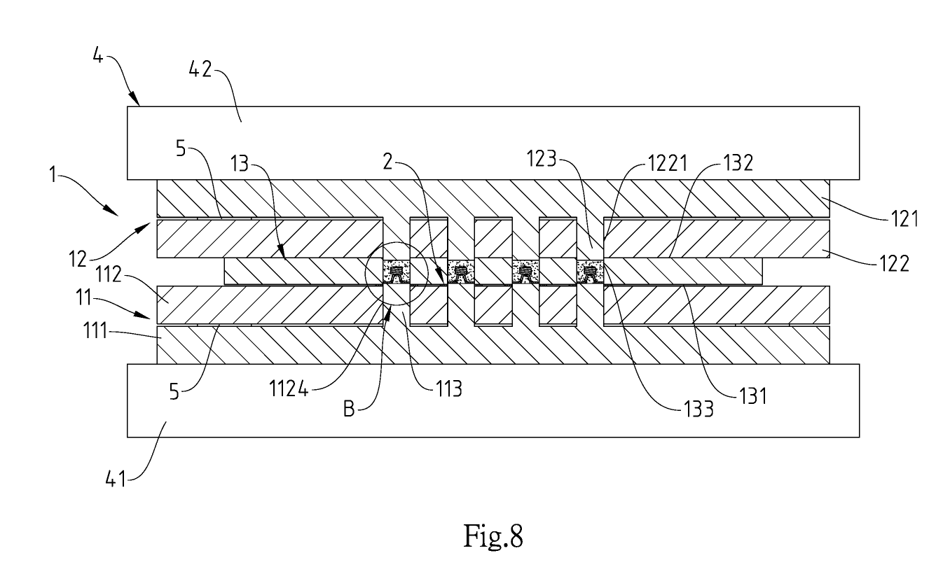

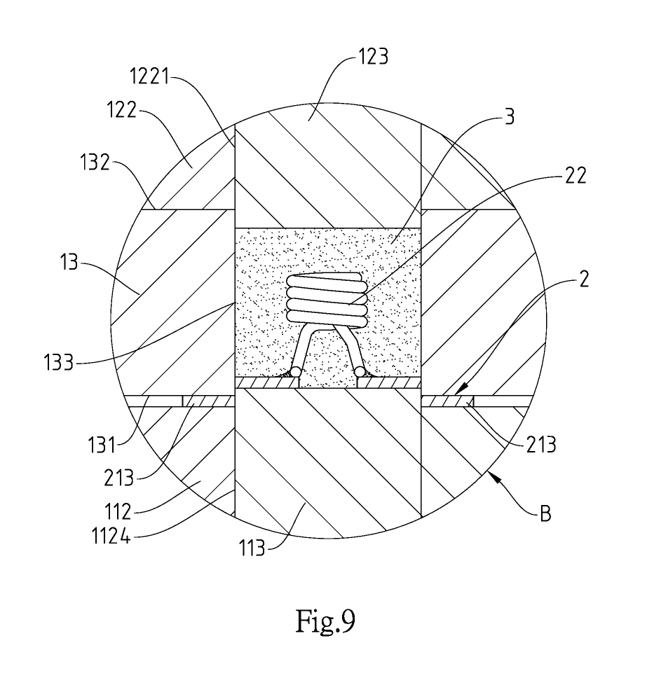

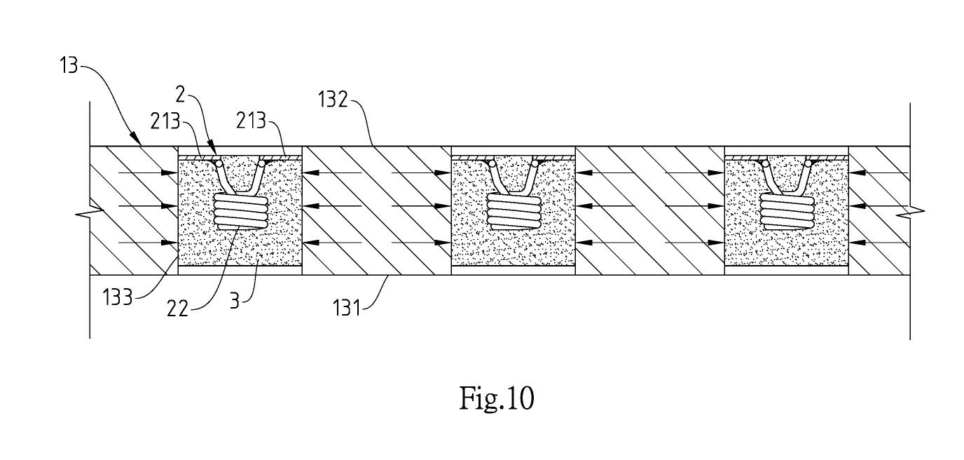

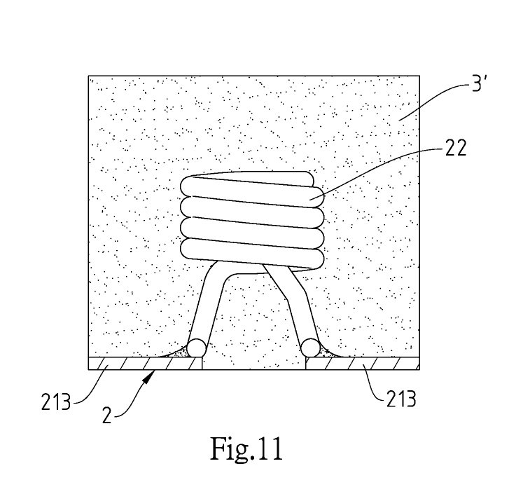

Referring to FIGS. 6-11 and FIGS. 4 and 5 again, in the implementation of the present invention to make inductors 20, put the lead frame 21 of the material part 2 on the first bearing surface 131 of the movable fixture plate 13 to suspend the connected coils 22 in the respective forming spaces 133, and then fill magnetic powder 3 from the side of the second bearing surface 132 into the forming spaces 133, and keep the position-limiting notch 214 of the material part 2 in alignment with the positioning notch 134 of the movable fixture plate 13 and also keep the first position-limiting holes 215 of the material part 2 in alignment with the respective guide holes 135 of the movable fixture plate 13 the second position-limiting holes 216 of the material part 2 in alignment with the respective locating holes 136 of the movable fixture plate 13, and then put the movable fixture plate 13 with the material part 2 in between the forming mold 11 and the stereotype plate 12 with the positioning notch 134 of the movable fixture plate 13 attached to the positioning post 1121 of the forming mold 11, the locating holes 136 of the movable fixture plate 13 coupled to the respective support columns 1122 of the forming mold 11 and the guide holes 135 coupled to the respective locating pins 1123 of the forming mold 11. At this time, the movable fixture plate 13 is positioned on the forming mold 11, the forming spaces 133 of the movable fixture plate 13 are respectively kept in alignment between the respective upper punches 123 of the stereotype plate 12 and the respective lower punches 113 of the forming mold 11, and the lead frame 21 of the material part 2 is positively held in between the movable fixture plate 13 and the forming mold 11. Thereafter, operate the punching machine 4 to move the upper mold base 42 with the stereotype plate 12 downward and the forming mold 11 upward, forcing the upper punches 123 of the stereotype plate 12 downwardly into the respective forming spaces 133 to preload and squeeze the magnetic powder 3, and simultaneously forcing the lower punches 113 of the forming mold 11 upwardly into the respective forming space 133 to cut into the lead frame 21, and thus, the electrode pieces 213 are cut off from the lead frame 21 and pushed with the respective coils 22 into the respective forming spaces 133 and the magnetic powder 3 is squeezed again. Thereafter, operate the punching machine 4 to move the upper mold base 42 with the stereotype plate 12 back to initial position, and then remove the movable fixture plate 13 with the compressed magnetic powder 3 and cut-off lead frame 21 out of the forming mold 11 and the lower slider 112, and then bake the movable fixture plate 13 with the coils 22 and the magnetic powder 3 to cure the magnetic powder 3 in the forming spaces 133 of the movable fixture plate 13 into conductor bodies 3′. During the curing process, the magnetic powder 3 (conductor bodies 3′) is surrounded by the peripheral walls of the respective forming spaces 133 of the movable fixture plate 13, there is no space for lateral expansion, prohibiting the magnetic powder 3 from thermal expansion or cracking. Further, before taking the movable fixture plate 13 out of the forming mold 11, a polarity marking device is used to mart polarity marks on the side corresponding to the respective electrode pieces 213, and then bake the movable fixture plate 13. Alternatively, a baking process can be applied to the movable fixture plate 13 prior to the polarity marking process. After the polarity marking process and the baking process, remove the finished inductors 20 from the respective forming spaces 133 of the movable fixture plate 13.

What the invention claimed is:

1. A modular mold for making inductors, comprising a forming mold for positioning on a lower mold base of a punching machine, and a stereotype plate for positioning on an upper mold base of said punching machine, said forming mold comprising a plurality of lower punches arranged in an array, said stereotype plate comprising a plurality of upper punches arranged in an array and respectively aimed at said lower punches, wherein:
the modular mold further comprises a movable fixture plate, said movable fixture plate comprising a first bearing surface, a second bearing surface opposite to said first bearing surface, and a plurality of forming spaces cut through said first bearing surface and said second bearing surface and arranged in an array;
when making inductors, place a lead frame of a material part on said first bearing surface of said movable fixture plate to suspend a plurality of coils that are connected to said lead frame in the respective said forming spaces, and then fill a magnetic powder from the side of said second bearing surface into said forming spaces, and then put said movable fixture plate and said material part in between said forming mold and said stereotype plate to position said movable fixture plate on said forming mold and to let said lead frame of said material part be secured in between said movable fixture plate and said forming mold, and then operate said punching machine to move said upper mold base and said stereotype plate toward said forming mold to further force said upper punches of said stereotype plate into the respective said forming spaces against said magnetic powder, causing said lower punches of said forming mold to cut off electrode pieces from said lead frame to force the respective said electrode pieces into the respective said forming spaces, and then operate said punching machine to move back said upper mold base and said stereotype plate, and then remove said movable fixture plate out of said forming mold and said stereotype plate, and then baking said movable fixture plate to cure said magnetic powder in the respective said forming spaces.

2. The modular mold for making inductors as claimed in claim 1, wherein said forming mold comprises a lower template for mounting on said lower mold base of said punching machine to hold said lower punches, and a lower slider supported on said lower template and spaced from said lower template by a gap and movable relative to said lower template for enabling said lower punches to protrude over said lower slider.

3. The modular mold for making inductors as claimed in claim 2, wherein said lower slider comprises a positioning post, a plurality of support columns and a plurality of locating pins respectively upwardly extended from a top surface thereof and a plurality of through holes cut through opposing top and bottom surfaces thereof and respectively aimed at said lower punches, the length of said through holes being shorter than the length of said lower punches so that when said lower punches are movable with said lower template to insert into said through holes and to protrude over said lower slider.

4. The modular mold for making inductors as claimed in claim 1, wherein said stereotype plate comprises a substrate adapted for mounting on said upper mold base of said punching machine to hold said upper punches, and an upper slider supported on said substrate and spaced from said substrate by a gap and movable relative to said substrate for enabling said upper punches to protrude over said upper slider.

5. The modular mold for making inductors as claimed in claim 4, wherein said upper slider comprises a plurality of through holes respectively kept in alignment with said upper punches, said through holes having a length smaller than the length of said upper punches so that said upper punches are movable with said substrate to insert into said through holes and to protrude over said upper slider.

6. The modular mold for making inductors as claimed in claim 1, wherein said movable fixture plate further comprises a positioning notch located on a peripheral edge thereof, and a plurality of guide hole and a plurality of locating holes cut through said first bearing surface and said second bearing surface; said lower slider of said forming mold comprises a positioning post for positioning in said positioning notch of said movable fixture plate, a plurality of support columns for positioning in said guide holes of said movable fixture plate, and a plurality of locating pins for positioning in said locating holes of said movable fixture plate.
